(19) United States
(12) Patent Application Publication
(10) Pub. No.: US 2006/0096408 A1
(43) Pub. Date: May 11, 2006

(54) Bicycle stem having a positioning mechanism for re-positioning a handle

(75) Inventor: Jim Liao, Hu Kol Hsiang (TW)

Correspondence Address: TROXELL LAW OFFICE PLLC;SUITE 1404, 5205 LEESBURG PIKE, FALLS CHURCH, VA, 22041, US

(73) Assignee: Hsin Lung Accessories Co., Ltd.

(21) Appl. No.: 10/984,816

(22) Filed: Nov. 10, 2004

(51) Int. Cl. B62K 21/12

(52) U.S. Cl. 74/551.1

(57) ABSTRACT

A bicycle stem having a positioning mechanism for re-positioning a handle comprises a vertical tube; an adaptor having a bore and an extension, wherein the bore receives therein the vertical tube so that the adaptor can rotate about the vertical tube; a lateral tube with a front end having a clamp for locking the handle, and a rear end pivotally connected to the extension of the adaptor; and a positioning mechanism comprising a rod for fixing the adaptor on the vertical tube as the adaptor is rotated to the required position about the vertical tube.

### BACKGROUND OF THE INVENTION

1. Field of the Invention

The present invention relates to a bicycle stem having a positioning mechanism for re-positioning the bicycle handle, in particular to a positioning mechanism which allows the stem to be turned so that the length of the handle clamped on the stem is re-positioned to be parallel to the length of the bicycle body.

2. Description of the Related Art

Referring to FIG. 1, the bicycle handle 1 is provided for gripping by both hands of the rider for controlling the direction and is thus somewhat long. When parking the bicycle 2, the bicycle handle 1 with such length makes it easy for the clothing of passers-by to be accidentally hooked by the two ends 3,4 of the handle 1 or for passers-by to accidentally bump against the handle 1, which could cause the bicycle 2 to fall to the ground. In addition, such bicycle handle 1 results in the necessity to occupy a larger parking space. If a number of bicycles are parked side by side, the length of the bicycle handle 1 requires that a greater width of the parking space is necessary and this results in reducing the number of available parking space within a specific area. Sometimes when the bicycle is parked in the stairways of a building, the space occupied is so large that the residents must walk around it to be able to pass.

### SUMMARY OF THE INVENTION

Accordingly, an object of the present invention is to provide a bicycle stem having a positioning mechanism for re-positioning a handle. When the bicycle is parked, the length of the handle of the bicycle can be re-positioned to be parallel to the length of the bicycle body so as to reduce the sidewise width of the bicycle. In this way, the occupied parking space can be reduced and the clothing of passers-by will not be accidentally hooked by the handle.

To achieve the above object, the present invention provides a bicycle stem having a positioning mechanism for re-positioning a handle which comprises a vertical tube; an adaptor having a bore and an extension, wherein said bore receives therein said vertical tube so that the adaptor can rotate about the vertical tube; a lateral tube with a front end having a clamp for locking said handle, and a rear end pivotally connected to said extension of said adaptor; and a positioning mechanism comprising a rod for fixing the adaptor on the vertical tube as said adaptor is rotated to the required position about the vertical tube.

### BRIEF DESCRIPTION OF THE DRAWINGS

Other features and advantages of the present invention will become apparent in the following detailed description of the preferred embodiment with reference to the accompanying drawings, in which:

FIG. 1 is a perspective view of the conventional bicycle;

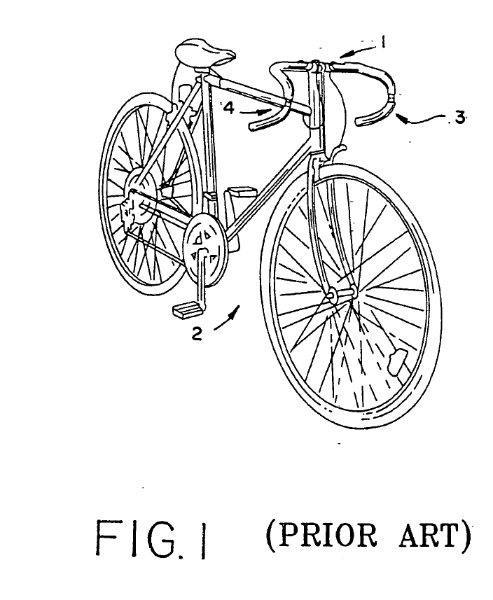

FIG. 2 is an exploded view of the present invention;

FIG. 3 shows the assembled form of the present invention;

FIG. 4 is a sectional view of the present invention; and

FIG. 5 is a schematic view of a preferred embodiment of the present invention.

### DETAILED DESCRIPTION OF THE PREFERRED EMBODIMENT

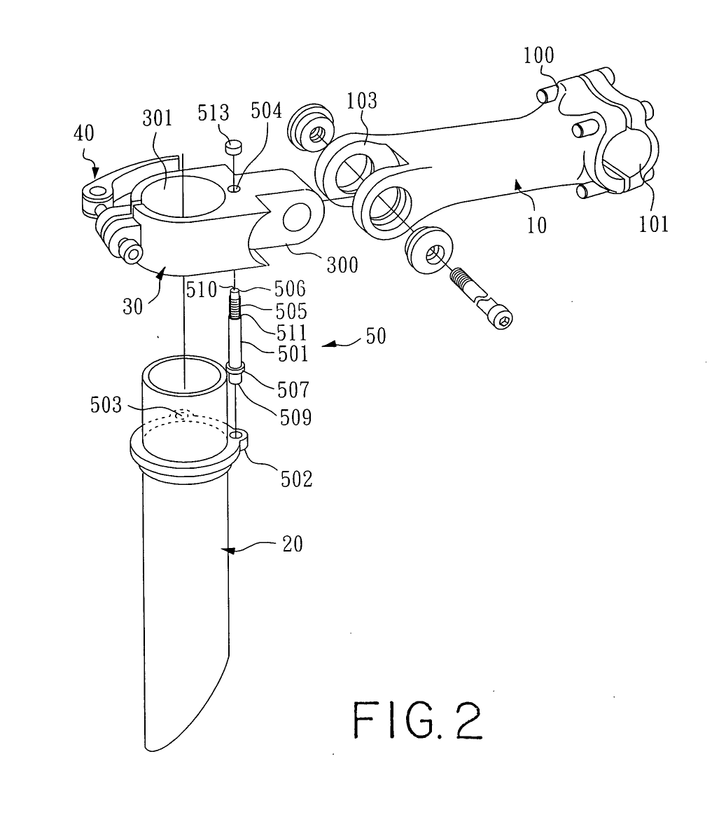

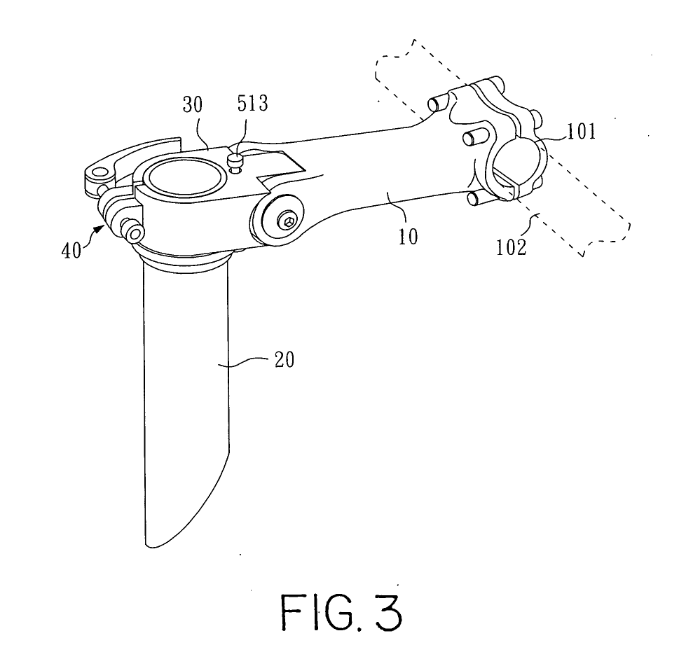

With reference to FIGS. 2, 3 and 4, the present invention, according to a preferred embodiment, comprises a lateral tube 10, a vertical tube 20, an adaptor 30, a quick-release mechanism 40 and a positioning mechanism 50.

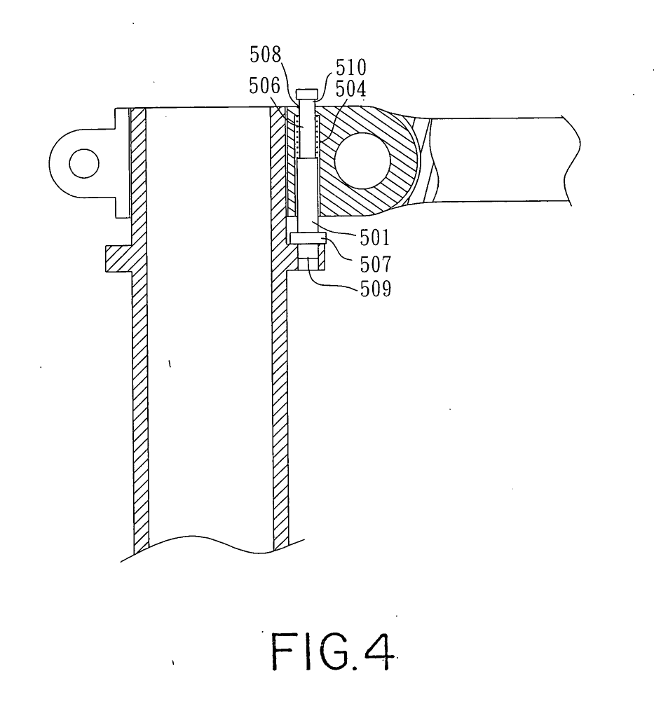

The lateral tube 10 has a front end 100 provided with a clamp 101 for locking a handle 102 and a rear end 103 pivotally connected to an extension 300 of the adaptor 30. The adaptor 30 has a bore 301 into which the vertical tube 20 is fitted. The quick-release mechanism 40 is provided on one side of the adaptor 30 and controls the bore 301 to either lock in place or release the vertical tube 20 received therein. The above construction is not an innovative feature of the present invention. The feature of the present invention resides in that the positioning mechanism 50 includes a rod 501, two positioning holes 502,503 provided on the outer tubular wall of the vertical tube 20 (most preferably, the two positioning holes 502,503 form a 90° angle therebetween), an aperture 504 provided on a longitudinal face of the extension 300 of the adaptor 30, and a compression spring 505 sleeved on the rod 501. The rod 501 has an upper section 506 of a reduced diameter (that is, a reduced tubular form) into which the compression spring 505 is sleeved, and a lower section provided with an annular ridge 507. In addition, the aperture 504 has a smaller diameter at the upper section 508 thereof (near the upper face of the extension 300), see FIG. 4, that is close to the tube diameter of the upper section 506 of the rod 501. As a result, as the rod 501 is inserted in the aperture 504, a bottom end 509 of the rod 501 is inserted in the positioning hole 502 with the annular ridge 507 abutting against the outer edges of the positioning hole 502, and the top end 510 extends out of the aperture 504. The top end of the compression spring 505 abuts against the inner edge of the aperture 504, while the lower end of the compression spring 505 abuts against the bottom portion 511 of the upper section 506 of the rod 501.

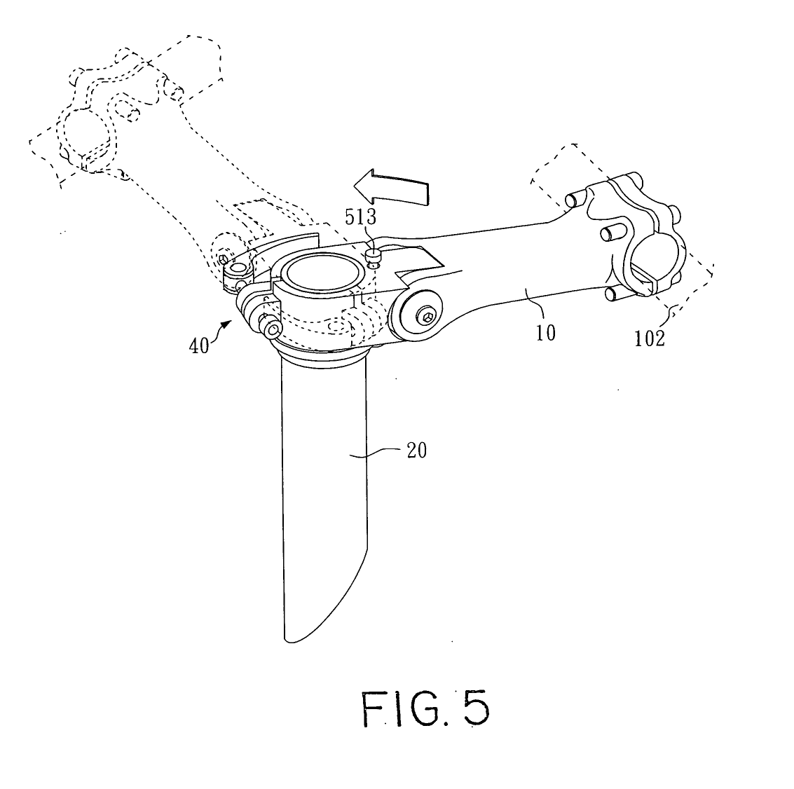

With reference to FIGS. 4 and 5, in order to re-position the handle 102 so that the length of the handle 102 is parallel to the length of the bicycle body, the quick-release mechanism 40 is released from the lock position, and the top end 510 of the rod 501 is pulled up (a pulling sleeve 513 may be provided at the top end 510 for convenient and easy pulling) so that the bottom end 509 is removed from the positioning hole 502 (at this point the compression spring 505 is subjected to compression). The adaptor 30 together with the lateral tube 10 can be rotated 90° about the vertical tube 20 until the bottom end 509 of the rod 501 is aligned with the other positioning hole 503. The bottom end 509 of the rod 501, being subjected to the restoring force of the compression spring 505, will by itself resiliently enter into the positioning hole 503. Thereafter, the quick-release mechanism 40 is locked again. The length of the handle 102 clamped on the clamp 101 of the lateral tube 10 is thus re-positioned to be parallel to the length of the bicycle body as well. Accordingly, the sidewise width of the bicycle is extensively reduced. In this way, the occupied parking space can be reduced and the clothing of passers-by will not be accidentally hooked by the handle.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A bicycle stem having a positioning mechanism for re-positioning the bicycle handle, comprising:
a vertical tube;
an adaptor having a bore and an extension, wherein said bore receives therein said vertical tube so that the adaptor can rotate about the vertical tube; and
a lateral tube with a front end having a clamp for locking said handle, and a rear end pivotally connected to said extension of said adaptor;
characterized by further including a positioning mechanism, said positioning mechanism comprising a rod for fixing the adaptor on the vertical tube as said adaptor is rotated to the required position about the vertical tube.

2. A bicycle stem having a positioning mechanism for re-positioning a handle as claimed in claim 1, wherein said positioning mechanism further includes two positioning holes which are for insertion of said rod and preferably form a 90-degree angle therebetween.

3. A bicycle stem having a positioning mechanism for re-positioning a handle as claimed in claim 1, wherein said positioning mechanism further includes an aperture provided longitudinally on said extension of said adaptor, said rod being inserted in said aperture, and a compression spring being sleeved on said rod.
